(19) United States
(12) Patent Application Publication
(10) Pub. No.: US 2023/0394378 A1
(43) Pub. Date: Dec. 7, 2023

(54) Business transactions and workspace sharing platform for multiple tenants

(71) Applicant: Ricardo Cabrera, Miami, FL (US)

(72) Inventor: Ricardo Cabrera, Miami, FL (US)

(21) Appl. No.: 17/860,273

(22) Filed: Jul. 8, 2022

Related U.S. Application Data
(60) Provisional application No. 63/349,198, filed on Jun. 6, 2022.

(51) Int. Cl. G06Q 10/02; G06Q 10/10

(52) U.S. Cl. CPC G06Q 10/02; G06Q 10/1095

(57) ABSTRACT

A computer-implemented method for sharing a workspace among multiple tenants and providing a tenant-specific experience for a tenant's visitor comprises a step of providing a computer-implemented reservation portal configured to allow each tenant or each tenant's visitor to complete a self-reservation for the workspace for a desired period of time. Such reservation portal may be provided to be accessed via the Internet or by using a dedicated portable electronic device, such as a dedicated tablet, which may be positioned at the front desk of the shared workspace. The reservation portal may be further configured to allow the tenant to self-configure the tenant-specific experience for the tenant's visitor.

### CROSS-REFERENCE DATA

This US patent application claims a priority date benefit from a co-pending U.S. Provisional patent application No. 63/349.198 filed 6 Jun. 2022 by the same inventor and with the same title and incorporated herein in its entirety by reference.

### BACKGROUND

Without limiting the scope of the invention, its background is described in connection with an automated cloud-based software platform that allows multiple tenants of the same one or more shared workspaces to reserve and use the shared workspace and its resources as well as perform a variety of business transactions with their customers. More particularly, the invention describes the business platform with multiple channels configured to perform workspace sharing and business transactions for a diverse variety of businesses.

Modern-day workspace in the post-Covid era is no longer a conventional office space occupied by the same company throughout the duration of the workday. With many companies switching to a fully remote or partially remote workforce, the need for office sharing is expected to increase significantly in the years to come. This is particularly true for many downtown locations in the business centers of major cities, where the cost of renting these facilities is high and constitutes a big expense line for many small businesses. One way for these businesses to remain in prestigious geographical locations is to share the cost of these workspaces with other businesses, thereby reducing their expenses and increasing their profitability.

Conventional arrangements for sharing workspace are known in the art, for example, a plurality of individual offices and conference rooms with a shared coworking room. Scheduling software to use the coworking offices or conference rooms is also known in the art, including Internet-based scheduling software. Each tenant may have access to the shared resource and schedule its use using this software.

One example of such an approach is described in the U.S. Pat. No. 11,251,983, illustrating techniques for integrated booking of rooms and media resources, such as display devices in a shared workspace.

However, such scheduling software is typically limited to just this one function. Other business solutions software also exists, such as accounting software, client management software, purchasing and invoicing software, etc. Each individual business has to select, subscribe to, and train its employees on several business platforms that are selected to cumulatively support the business needs of each individual business.

In addition, another significant limitation of existing software solutions is that they predominantly focus only on the various needs of their business tenants and do not allow for customization and accounting for the priorities and needs of the visitors of these businesses. This need is especially acute for businesses of diverse nature sharing the same workspace, where the needs of their respective visitors may be quite different from one business tenant to another.

A further limitation of existing scheduling methods is that they are only accessible to the tenants and not their visitors. There are circumstances when the visitor or a customer of the tenant may want to initiate a meeting that may require a physical space. None of the existing scheduling methods allow initiation of the workspace reservation to be performed by the visitor of the tenant.

The need exists for simplified, universal business software that supports a variety of needs for a diverse range of small businesses including sharing of workspace, management of clients, accounting, marketing, and other common functions. The need also exists for simplified software that allows various businesses to address the needs of their visitors and allow further automation of the visitor's processing and experience while conducting business using the shared workspace.

### SUMMARY

Accordingly, it is an object of the present invention to overcome these and other drawbacks of the prior art by providing a novel method for sharing a workspace among multiple tenants and providing a tenant-specific experience for a visitor of the tenant.

It is another object of the present invention to provide a novel method for sharing workspace between multiple tenants and their visitors in a single, easy-to-operate platform that is customizable for the needs of various small and medium-sized businesses.

It is a further object of the invention to provide either the tenant or the tenant's visitor an ability to initiate the reservation of the required shared workspace to facilitate conducting business between the visitor and the tenant.

It is a further object of the present invention to provide a novel method for sharing workspace allowing each tenant to book and share workspace through multiple parallel channels.

It is yet a further object of the present invention to provide a novel method for sharing the workspace between multiple tenants with customizable check-in and check-out procedures, that can be performed automatically for a variety of respective visitors and customers of the tenants sharing the workspace.

It is a further yet objective of the present invention to seek visitors' feedback at the conclusion of the visit with the tenant. The feedback may be collected as part of the outgoing experience and may be shared with the tenant.

The novel computer-implemented method for sharing a workspace among multiple tenants and providing a tenant-specific experience for a tenant's visitor may include the following steps:
a. providing a computer-implemented reservation portal configured to allow each tenant or tenant's visitor to complete a self-reservation for the workspace for a desired period of time. Such reservation portal may be provided to be accessed via the Internet or by using a dedicated portable electronic device, such as a dedicated tablet, which may be positioned at the front desk of the shared workspace. The reservation portal may be further configured to allow the tenant to self-configure the tenant-specific experience for the tenant's visitor. Two broad categories of the configurable visitor experience may include:
   i. a tenant-specific incoming experience for the tenant's visitor before the visit to the reserved workspace, for example a check-in experience, signing a tenant-specific non-disclosure document, etc. or
   ii. a tenant-specific outgoing experience for the tenant's visitor after the visit to the reserved workspace, such as a payment for the tenant's services or signing a contract with the tenant;
b. upon arrival and self-identification of the tenant's visitor, such as by entering the visitor's name or phone number, operating the computer-implemented visitor's portal to provide the tenant's visitor with the tenant-specific incoming experience as in step (a) if available,
c. operating the computer-implemented visitor's portal to direct the visitor to the reserved workspace, such as a specified conference room or an office, and
d. upon completion of the visit with the tenant, operating the computer-implemented visitor's portal to provide the tenant's visitor with the tenant-specific outgoing experience as in step (a) if available.

In broad terms, the novel method and the business platform for implementing the method of the present invention combine the functions of multiple individual software packages into a single, easy-to-operate package that is customizable for the needs of various small and medium businesses. It allows to book and share co-working space through multiple parallel channels, such as a cloud-based marketplace, tenant's website, dedicated electronic device with a suitable user interface, etc.

In particular, it allows multiple tenants to perform check-in and check-out procedures, including multi-tenant appointment sign-in and filling of business-specific electronic forms, such as intake forms, confidentiality agreements, background information forms, etc.

It further allows payments for goods and services during check-out procedures, as well as filling feedback forms that are routed back to the tenants for customer feedback and follow-up.

The platform may be driven by a customized front desk experience tablet providing a universal interface for incoming and outgoing visitors for a variety of tenant businesses.

The term “tenant” is used herein to describe an organization with contractual rights to the shared workspace. Each tenant may have a tenant ID, which can be used to identify the tenant in the novel software of the present invention. Each tenant may have one or more employees or contributors, each of whom may be assigned a distinct employee or personal ID associated with the tenant ID. Each reservation process performed by a visitor may involve selecting a desired tenant as well as selecting desired employee or a person within the selected tenant organization.

In a further aspect of the present invention, the computer-implemented portal may be further configured to operate in a multi-tenant or a single-tenant mode. While in either mode, it may be further configured to operate in a multi-person mode if a particular tenant has more than one employee or person associated therewith. One advantage of this flexibility is that when a tenant “graduates” from a workspace sharing arrangement to occupy their own workspace full time, they can continue to use the software based on the novel method of the present invention and operate in a single-tenant multi-person mode where individuals of that tenant and their respective visitors have the ability to reserve common area resources and space using the same front desk tablet and other familiar access methods to the server portal.

In a further aspect of the invention, a novel computer-implemented method for sharing a workspace among multiple tenants and their visitors as well as providing a tenant-specific experience for a tenant's visitor may include the following steps:
a. providing a computer-implemented reservation portal configured to allow each tenant or authorized tenant's visitor to complete a self-reservation for the workspace for a desired period of time. The portal may be configured to confirm the reserved shared workspace to both the tenant and the tenant's visitor upon recording a reservation from either one of them. The portal may be further configured to accept payment for the shared workspace from the tenant in response to the reservation notification confirming the reservation made by either party. Alternatively, the portal may also accept payment directly from the visitor and provide a payment confirmation or notification to the tenant,
b. upon arrival and self-identification of the tenant's visitor, such as by entering visitor's name or phone number, operating the computer-implemented visitor's portal to provide the tenant's visitor with the tenant-specific incoming experience, if configured by the tenant prior to the visit,
c. operating the computer-implemented visitor's portal to direct the visitor to the reserved workspace, such as a specified conference room or an office, and
d. upon completion of the visit with the tenant, operating the computer-implemented visitor's portal to provide the tenant's visitor with the tenant-specific outgoing experience, if configured by the tenant prior to the visit.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through the use of the accompanying drawings, in which:

FIGS. 1a and 1b together is a block diagram of exemplary steps that may be taken by the visitor of the tenant in reserving the shared workspace,

FIGS. 2a and 2b together is a block diagram of exemplary steps that may be taken by the tenant in reserving the shared workspace,

FIG. 3a is a block diagram of exemplary steps that may be taken by a tenant upon arrival to the shared workspace,

FIG. 3b is an alternative block diagram of exemplary steps that may be taken by a tenant upon arrival to the shared workspace for reserving and using the shared workspace right afterward,

FIGS. 4a and 4b together is a block diagram of exemplary steps that may be taken by the visitor of the tenant before and after using the shared workspace, and

FIGS. 5a and 5b together is an alternative block diagram of exemplary steps that may be taken by the visitor of the tenant before and after using the shared workspace.

### DETAILED DESCRIPTION OF PREFERRED EMBODIMENTS OF THE INVENTION

The following description sets forth various examples along with specific details to provide a thorough understanding of claimed subject matter. It will be understood by those skilled in the art, however, that claimed subject matter may be practiced without one or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The novel method of using a shared workspace is based on using cloud-based computing including wired and/or wireless access to a cloud-based server, which may include one or more connected computer servers. Interaction with the cloud-based computer server operating the steps of the novel method of the invention may be done using a computer-implemented reservation portal.

The portal may be operated using one, two, or several parallel access methods. One example of a suitable access method is a web-based access interface, which may be provided using a dedicated access software running on a tenant's or visitor's computer, smartphone, or another conventional electronic device. The interactive software may be configured to provide customization and scheduling access to some or all of the features described below in greater detail.

Another suitable access method to operate the portal may include the use of a dedicated electronic device configured to provide such access, for example, an electronic tablet located in a commonly accessible space to all tenants and/or visitors of the shared workspace. The tablet may be password-protected to guard against unauthorized use. The tablet interface may be adaptive depending on the time of the day according to the schedule of reserved activities and the use of the workspace. The tablet may be located at the reception or front desk area of the facility and may be encountered by visitors and tenants upon entering the premises. Other small electronic devices may also be configured to run access software. Examples of such electronic devices include a smartphone and a smartwatch.

A further useful access method may be email-based and may be configured for automatic processing of email requests for the shared workspace from authenticated emails known to be associated with the tenants that have a right of using the workspace to conduct their business.

Further examples of useful access methods allowing scheduling of the use of a shared workspace may include a message-based access, a phone number-based access, and a voice-recognition based access methods, all or at least some of which may also include automated speech or voice recognition functionality to facilitate a transfer of a tenant or visitor request to a completed (and, at least in some cases, paid for) reservation of the shared workspace for a desired period of time.

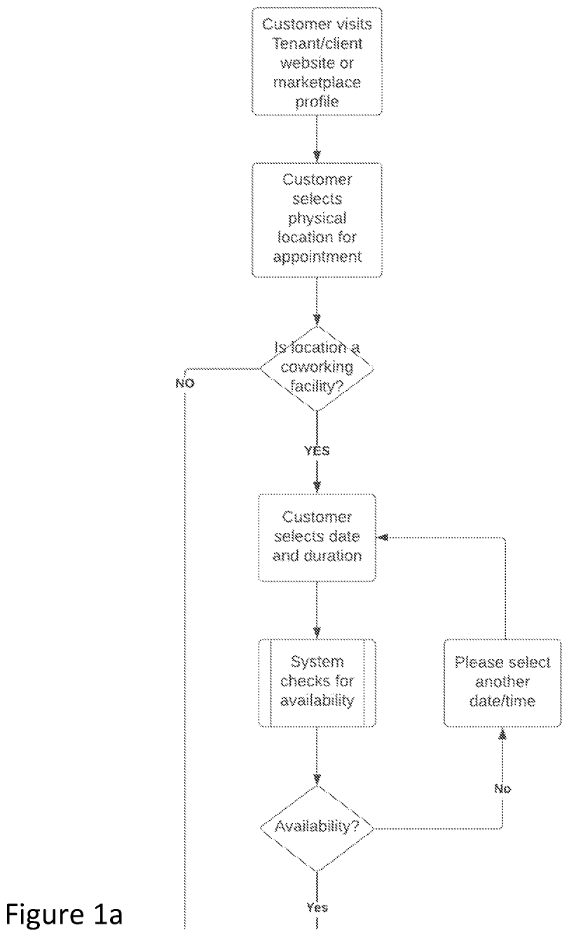

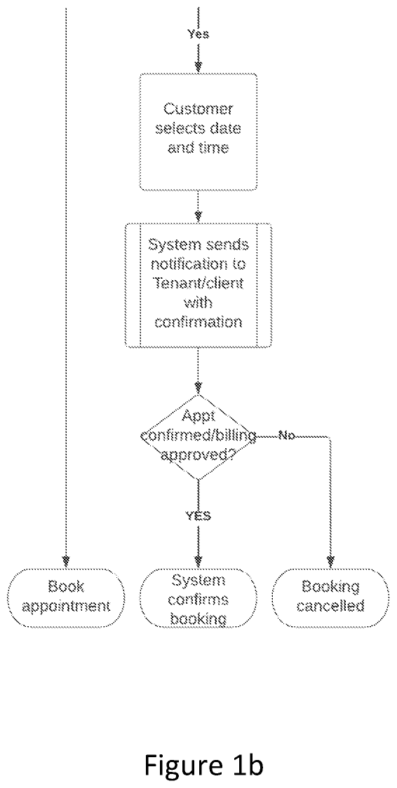

The novel method of the invention is aimed at expanding the limited capabilities of conventional scheduling approaches for sharing workspace between multiple tenants to include their visitors and customers in the process of scheduling and using the workspace. One new feature of the new method is allowing both the tenants as well as their visitors to initiate the scheduling request process. FIGS. 1a and 1b show an exemplary block diagram of steps that may be taken by the visitor of a tenant in reserving a workplace for conducting business with that tenant. Access to the reservation portal may be provided via a tenant's website or by other access methods as described above. Once a request for a workplace is received by the cloud-based server, it may be configured to send a notification to the tenant and complete the reservation upon approval by the tenant and, at least in some cases, upon payment by the tenant (or, in some cases, by the visitor) of the fee associated with the use of the shared workspace. The server may be further configured to coordinate the reservation of the shared workspace between the tenants and their visitors so as to avoid duplication of reservations. In one example, once a shared workspace is reserved by the visitor or a particular tenant, no further reservation is allowed for the same visitor by the tenant. In another example, once a visitor completed the reservation, a notification is sent to the tenant inviting the tenant to configure the visitor's experience. In yet another example, additional reservations may be allowed to be done by the tenant but after checking off a suitable warning signal notifying the tenant that at least one reservation by the visitor is already recorded.

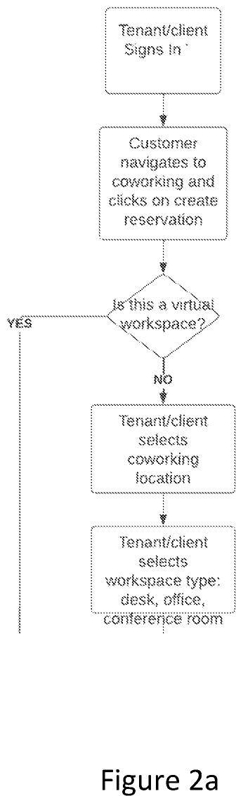

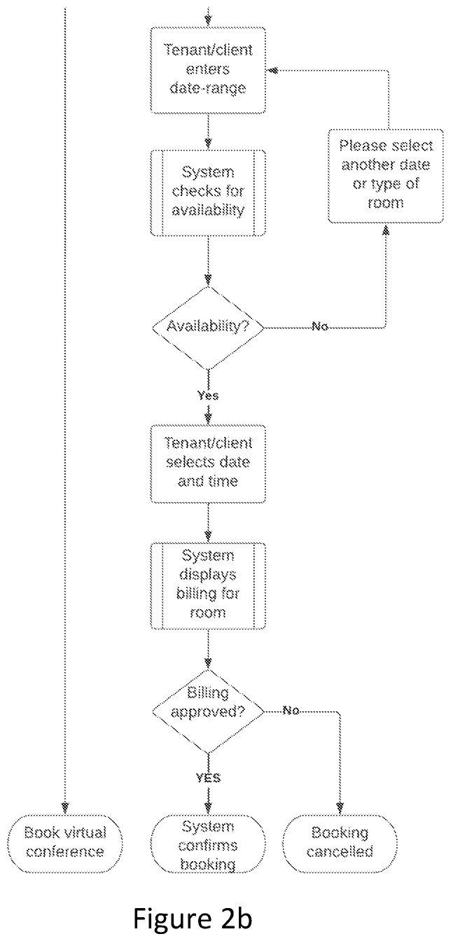

FIGS. 2a and 2b show a similar workflow block diagram but this time the reservation is performed by the tenant of the shared workspace.

In embodiments, reservation of the workspace is not limited to a conventional notion of a conference room or an office. It may also include other facilities and/or resources and equipment. One example is a shared playroom, which may be used by a children's service group during the day and by an elderly service group at night. Another example is sharing partial or full access to a swimming pool between different users and groups. Shared use of sports facilities, stadiums, playgrounds, licensed kitchens, restaurants, etc. is all considered to be within the scope of the present invention.

In other embodiments, additional visit details may be specified and customized by the tenant or the tenant's visitor, such as the temperature in the room, delivery of food or drinks at a specified time, etc.

The computer-implemented reservation portal may be configured to allow each tenant and/or their verified visitors or customers to complete a self-reservation for the workspace for a desired period of time. In addition, the reservation portal may be further configured to allow the tenant to self-configure a tenant-specific experience for the tenant's visitor. The term “visitor experience” is used herein to describe all electronic interaction with the portal and/or server that is anticipated to be done by the visitor during the visit to the tenant. The visitor experience may be generally organized in one or both of the following two ways:
i. a tenant-specific incoming experience for the tenant's visitor before the visit to the reserved workspace, or
ii. a tenant-specific outgoing experience for the tenant's visitor after the visit to the reserved workspace.

The tenant-specific incoming experience may be adapted based on the needs of a specific business tenant. It may include check-in forms, non-disclosure agreements, work applications, patient's medical history, and other e-forms.

Examples of tenant-specific outgoing experience may include the signing of documents discussed during the visit, completion of agreements, payment for services, schedule of follow-up visits, and other e-forms. In addition, the customer feedback may be sought, such as a questionnaire or a simple rating of the visitor's experience. Upon completion, both incoming and outgoing e-forms and feedback may be provided to the tenant as well as in some cases used for the improvement of customer service, training purposes, and other authorized uses.

As the method of the invention is intended to support a diverse variety of businesses and their customers, the computer-implemented reservation portal may be configured to provide the tenant-specific experience for the tenant's visitor in one or more of the following categories:
i. the visitor as a consumer or a client of the tenant's goods or services,
ii. the visitor as a vendor of goods or services to the tenant, and
iii. the visitor as neither a consumer or a client nor a vendor for the tenant.

Each category may have a prefilled electronic template for suitable forms and documents that may be customized further by the tenant depending on specific business circumstances for that particular business.

After completion of a step of reserving the workspace and creating an incoming and/or outgoing tenant-specific visitor experience using the computer-implemented reservation portal, the method of the invention may include further steps of actually using the shared workspace according to the configured details specified during the reservation step.

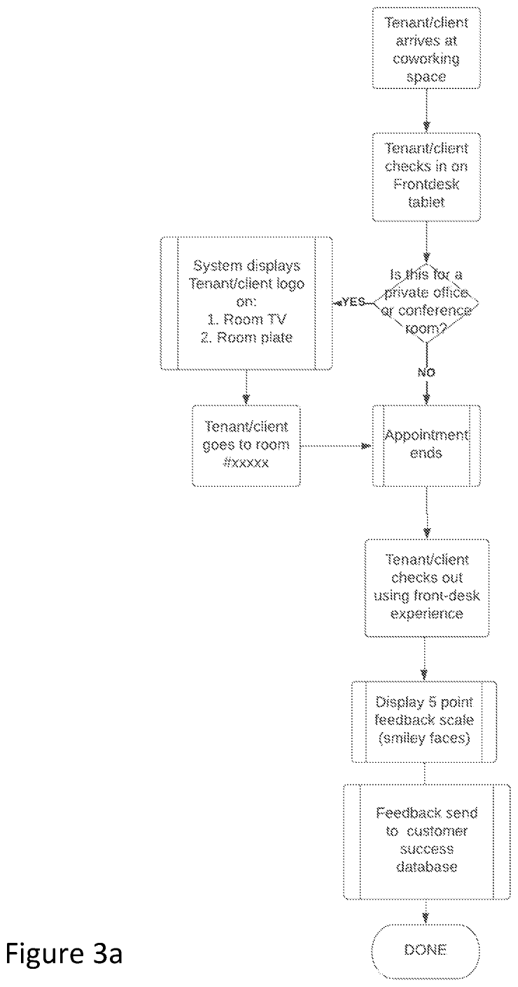

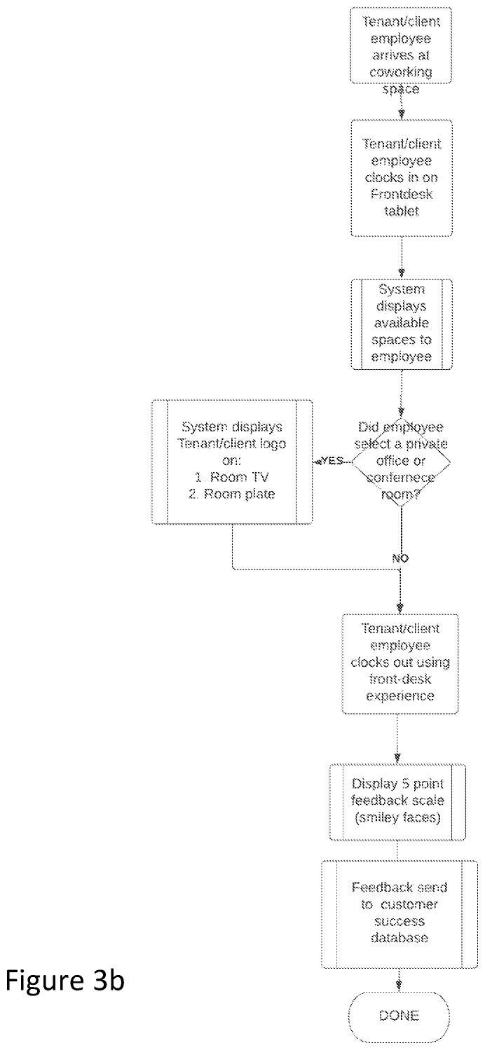

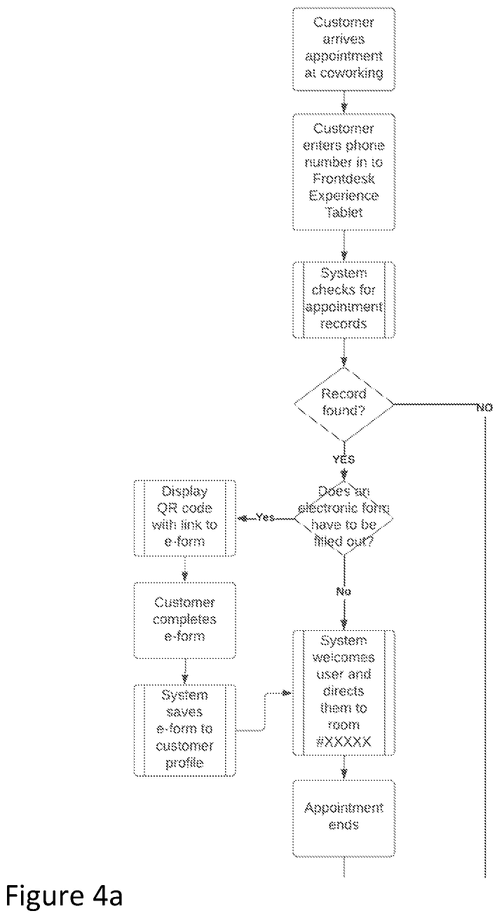

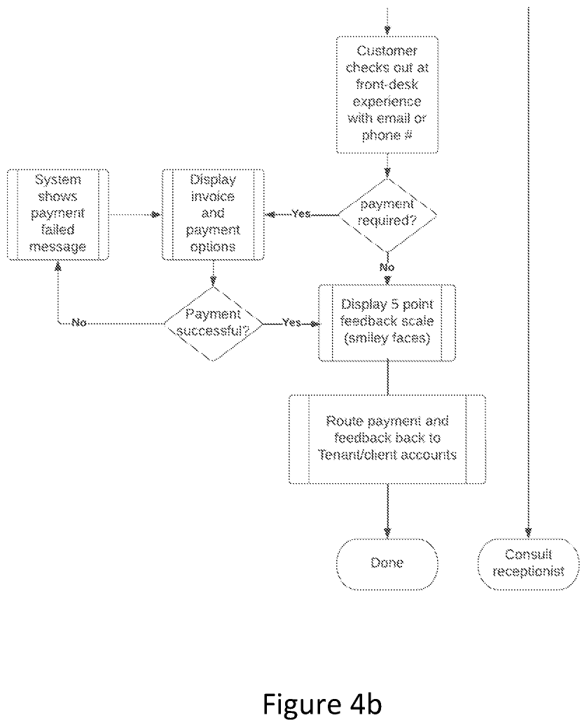

In embodiments, tenant's arrival steps are shown in greater detail in FIG. 3a. Upon the arrival and self-identification of the tenant's visitor using a visitor's portal (such as by entering a name or a phone number into a self-operated tablet), the method may include a step of operating the computer-implemented visitor's portal to provide the tenant's visitor with the tenant-specific incoming experience as outlined above—see FIGS. 4a and 4b. In one example, the reservation portal may provide tenant-specific documents to the tenant's visitor to review or sign as part of the tenant-specific incoming experience before visiting with the tenant. Completion of required or optional e-forms may trigger the computer-implemented visitor's portal to direct the visitor to the reserved workspace.

Upon completion of the visit with the tenant, the method of the invention may further include a step of operating the computer-implemented visitor's portal to provide the tenant's visitor with the tenant-specific outgoing experience as outlined above, for example providing tenant-specific documents to the tenant's visitor to review or sign as part of the tenant-specific outgoing experience after visiting with the tenant.

A further step of the method may include automatically creating a request for payment for the reserved workspace and the axillary service using a corresponding predetermined workplace and axillary services schedules of charges as described in greater detail below. The visitor may also be provided with an option to make a payment using the same portal. In further embodiments, request for payment may be based on using at least one predetermined schedule of charges for workspace or axillary services, which may be adjusted automatically prices based on a demand level and geographical location preference. One example of such adjustment is so-called “surge prices” that provide for higher payments at peak demand times.

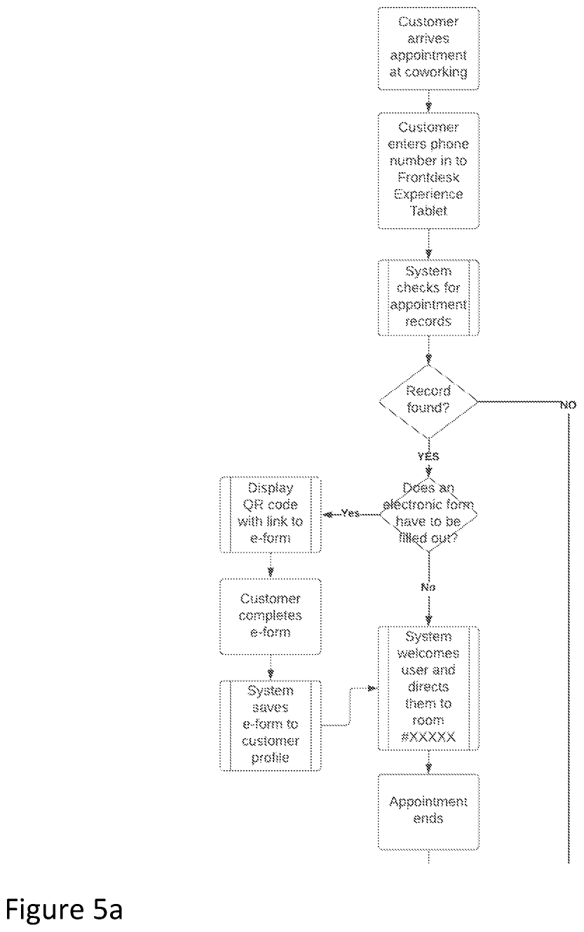

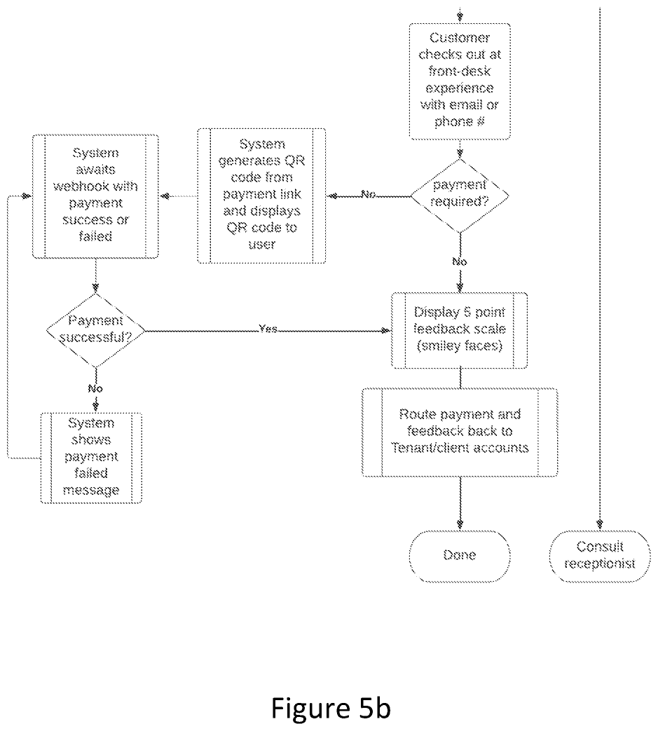

The visitor's portal may be further configured to seek visitors' feedback for the tenant. The visitor may then automatically check out and leave. Examples of steps taken by the visitor both before and after the visit with the tenant are seen in FIGS. 4a and 4b (using steps aided by the use of a QR-code or another scannable code) as well as in FIGS. 5a and 5b that show QR-code-aided steps including providing a link for making a payment at the end of the visit.

The hardware associated with the method of the invention may not be limited to a front desk tablet operating in a mode of a reservation portal or a visitor's portal. It may also include displays, TV and computer monitors, and e-signs indicating the name of the tenant in the room reserved as a workspace throughout the reserved time period. It may also include projecting certain tenant-specified images or video files on the monitor in and outside the reserved workspace or operating another electronic device configured to support the purposes of the meeting.

Additional optional hardware may be configured to automatically determine the presence of the tenant or the visitor in the reserved workspace. Once both the tenant and the visitor are determined to have left the workspace, the method of the invention may include a step of making the workspace available even if it was reserved for a longer period of time by the tenant. Examples of suitable hardware that can support this function may include proximity sensors, video cameras, and other devices that can detect the presence of people in the room. In further embodiments, using such hardware automatically may include a step of registering the tenant upon arrival and departure, thereby creating a record of the time when the workspace was used by the tenant. Such record may be used in some cases for automated billing for the use of premises based on actual usage time, rather than based on a reserved time record.

In further embodiments, facial or other biometric recognition devices may be used to further facilitate checking in of the tenants and/or their visitors as the invention is not limited in this regard.

In addition to reserving the workspace for a specified period of time, the computer-implemented reservation portal may be further configured to reserve an axillary service for either the tenant or the tenant's visitor before, during, or after the desired period of time for the reservation of the workspace. In one example, such axillary service may include service by another tenant, such as a babysitting service for a tenant's visitor. This may improve customer retention by the tenant as well as allow the customer to visit the tenant without a worry for their unattended children. Similar other examples of axillary services may include arranging transportation for the tenant or the visitor to and from the location of the shared workspace, a pet care service, a goods packaging and mailing service, a recreational or sports activity accompanied with corresponding reservation resources, and an appointment reminder service.

The method of the invention may further comprise a step of providing various notifications and reminders to the tenant as well as to the visitor of the tenant. Such notifications may include confirmations of the reserved workspace and any subsequent adjustments or changes thereto, payment confirmations, copies of proposed and signed documents, confirmation of follow-up appointments, reservations of axillary services, etc.

As discussed above, one of the unique features of the present method is providing an ability for the visitor of the tenant to reserve the workspace as needed for conducting business with the tenant. In further embodiments, the visitor may also be given an option to select a preferred time for such a reservation. In some cases, a plurality of available times may be provided by the tenant as part of setting up the reservation portal, while in other cases, the reservation portal may be configured to accept the desired time suggested by the visitor.

In further embodiments, the reservation portal may be configured to organize a waiting list for either tenants or tenant visitors in case of last-minute cancellations. The reservation portal may be configured to fill available time for the shared workspace with the tenants or visitors from the waiting list if the requested workspace may become available.

Since the proliferation of virtual meetings and virtual meeting rooms and places, the present invention is not limited to reserving a physical workplace. In other embodiments, the workspace may be assumed to be either physical or virtual. In this case, the computer-implemented reservation portal may be configured to assign the physical workspace according to a first availability schedule and the virtual workspace according to a second availability schedule. Examples of the virtual workspace may include virtual meetings and conferences, in which case the reservation portal may be configured in one example to play selected prerecorded video files at selected virtual meeting times to the meeting participants.

More than one location with a similar available workspace may be managed within the scope of the present invention. In this case, the reservation portal may be configured to offer more than one location and more than one available time for both the tenant and/or the visitor to complete the reservation. One advantage for the tenant and the visitor is the ability to select a suitable option at a lower price. Furthermore, the reservation portal may be further configured to operate at more than one predetermined schedule of charges depending on a particular location of the workspace. In this case, the step of using at least one predetermined schedule may further includes a step of generating a recommendation to the tenant or the visitor of a lower price alternative option based on a different reservation time or an alternative geographical location if available.

In further embodiments of the method of the invention, additional business software modules may be offered and bundled with the reservation portal as described above. This may have the advantage of having common interface features, thereby reducing tenants' training needs in using the entire software package. Some suitable examples of additional business software modules include a tenant's website software, tenant-specific e-commerce software, front desk software, digital marketing software, accounting software, human resource software, online marketplace software, quotes and estimates software, products and inventory management software, and customer roster and management software.

In further yet embodiments of the invention, there may be no need to reserve the shared workspace in advance. In these embodiments, at least one, several, or all authorized employees or persons working for a particular tenant may be allowed to show up at the coworking space, identify themselves to the server via a badge, a name, or a phone number, select desired shared workspace among what is available at that time (such as a desk or a private office) and be directed by the portal to the selected space, see FIG. 3b. In case they have visitors or customers with them or arriving shortly, they can also configure the visitor's experience at the same time, for example by calling certain e-forms and documents such as a non-disclosure agreement. The visitor would be asked to complete these e-forms as part of the visitor's incoming experience. Once the reservation is complete, the use of the shared workspace (with the visitor or without a visitor) may proceed immediately afterward. Upon exit, the time of use of the shared workspace by that tenant and/or visitor may be automatically logged in into the portal record and an invoice for the use of the shared workspace may be generated and automatically sent to the tenant. One advantage of this approach is greater flexibility for the tenant in using the shared workspace as no preliminary reservation is necessary and the facility may be used “on-demand” in real-time.

In other contemplated embodiments, the invoice for the use of the shared workspace may be generated using either the duration of the time based on a reservation or the actual duration of use based on the automated record generated by the clocking-in and clocking out actions of the tenant or its employees.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, Aft BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12, 15, 20 or 25%.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A computer-implemented method for sharing a workspace among multiple tenants and providing a tenant-specific experience for a tenant's visitor, the method comprising the following steps:
a. providing a computer-implemented reservation portal configured to allow each tenant to complete a self-reservation for the workspace for a desired period of time, wherein the reservation portal is further configured to allow the tenant to self-configure the tenant-specific experience for the tenant's visitor comprising at least one of:
i. a tenant-specific incoming experience for the tenant's visitor before the visit to the reserved workspace, or
ii. a tenant-specific outgoing experience for the tenant's visitor after the visit to the reserved workspace,
b. upon arrival and self-identification of the tenant's visitor, operating the computer-implemented visitor's portal to provide the tenant's visitor with the tenant-specific incoming experience as in step (a) if available,
c. operating the computer-implemented visitor's portal to direct the visitor to the reserved workspace, and
d. upon completion of the visit with the tenant, operating the computer-implemented visitor's portal to provide the tenant's visitor with the tenant-specific outgoing experience as in step (a) if available.

2. The computer-implemented method as in claim 1, wherein in step (a) the computer-implemented reservation portal is further configured to be accessible to each tenant and/or tenant's visitor via at least two access methods.

3. The computer-implemented method as in claim 2, wherein the access methods to the computer-implemented reservation portal in step (a) are selected from a group consisting of a web-based access interface, a dedicated electronic device configured to provide the access, an email-based access, a message-based access, a phone number-based access, and a voice-recognition based access.

4. The computer-implemented method as in claim 1, wherein the reservation portal in step (a) is further configured to provide the tenant-specific experience for the tenant's visitor in one or more of the following categories:
i. the visitor as a consumer or a client of the tenant's goods or services,
ii. the visitor as a vendor of goods or services to the tenant, and
iii. the visitor as neither a consumer or a client nor a vendor for the tenant.

5. The computer-implemented method as in claim 1, wherein the computer-implemented reservation portal in step (a) is further configured to provide tenant-specific documents to the tenant's visitor to review or sign as part of the tenant-specific incoming experience before visiting with the tenant.

6. The computer-implemented method as in claim 1, wherein the computer-implemented reservation portal in step (a) is further configured to provide tenant-specific documents to the tenant's visitor to review or sign as part of the tenant-specific outgoing experience after visiting with the tenant.

7. The computer-implemented method as in claim 6, wherein the computer-implemented reservation portal in step (a) is further configured to provide the visitor with an option to make a payment via thereof either before or after the visit with the tenant.

8. The computer-implemented method as in claim 6, wherein the computer-implemented reservation portal in step (a) is further configured to provide the visitor with an option to record a feedback to the tenant after the visit therewith.

9. The computer-implemented method as in claim 1, wherein the computer-implemented reservation portal in step (a) is further configured to reserve an axillary service for either the tenant or the tenant's visitor before, during, or after the desired period of time for reservation of the workspace.

10. The computer-implemented method as in claim 9, wherein the axillary service is selected from a group consisting of a service by another tenant, a transportation service to or from the workspace, a childcare service, a pet care service, a goods packaging service, a recreational or sports activity and corresponding resources, and an appointment reminder service.

11. The computer-implemented method as in claim 1 further comprising a step of providing an automated notification to the tenant and/or the tenant's visitor.

12. The computer-implemented method as in claim 11, wherein the notification is selected from a group consisting of a confirmation of an appointment, a reminder of an upcoming appointment, a copy of documents pertaining to the appointment, a receipt for a payment pertaining to the appointment, a notification of a change of appointment time, and a confirmation for an axillary service pertaining to the appointment.

13. The computer-implemented method as in claim 1, wherein the computer-implemented reservation portal in step (a) is further configured to allow the tenant's visitor to select a preferred appointment time among several options specified by the tenant.

14. The computer-implemented method as in claim 1 further comprising a step of providing an additional business software module to support at least one tenant, wherein the additional business software module and the computer-implemented reservation portal have common interface features, thereby reducing tenant's training needs.

15. The computer-implemented method as in claim 14, wherein the additional business software module is selected from a group comprising a tenant's website software, tenant-specific e-commerce software, front desk software, digital marketing software, accounting software, human resource software, online marketplace software, quotes and estimates software, products and inventory management software, and customer roster and management software.

16. The computer-implemented method as in claim 1, wherein the workspace is either physical or virtual, and wherein in step (a) the computer-implemented reservation portal is configured to assign the physical workspace according to a first availability schedule and virtual workspace according to a second availability schedule.

17. The computer-implemented method as in claim 1, wherein step (a) further comprises an assignment of workspace-related resources to the tenant for the same reserved period of time as the reserved workspace.

18. The computer-implemented method as in claim 17, wherein the workspace-related resources are configured to be tenant-specific for the same reserved period of time as the reserved workspace.

19. The computer-implemented method as in claim 1 further comprising a step of automatically creating a request for payment for the reserved workspace and the axillary service using a corresponding predetermined workplace and axillary services schedules of charges.

20. The computer-implemented method as in claim 19, wherein the step of using at least one predetermined schedule of charges for workspace or axillary services further includes a step of adjusting prices based on a demand level and geographical location preference.

21. The computer-implemented method as in claim 20, wherein the step of using at least one predetermined schedule further includes a step of generating a recommendation to the tenant of a lower price alternative option based on a different reservation time or geographical location if available.

22. The computer-implemented method as in claim 1, wherein the step (b) further comprising a step of registering the tenant upon arrival and departure, thereby creating a record of time when the workspace was used by the tenant.

23. The computer-implemented method as in claim 1, wherein in step (a) the computer-implemented reservation portal is further configured to allow the tenant's visitor to initiate the reservation for the workspace for the desired period of time, subject to notification of and approval by the tenant.

24. The computer-implemented method as in claim 1, wherein the computer-implemented portal is further configured to provide currently available shared workspace options to allow reservation of the workspace immediately followed by its use.
